(19) United States
(12) Patent Application Publication
(10) Pub. No.: US 2019/0132128 A1
(43) Pub. Date: May 2, 2019

(54) AUTHENTICATION PROTECTION MECHANISM

(71) Applicant: QUALCOMM Incorporated, San Diego, CA (US)

(72) Inventors: Rosario CAMMAROTA, San Diego, CA (US); Jouni MALINEN, Tuusula (FI)

(21) Appl. No.: 16/177,563

(22) Filed: Nov. 1, 2018

Related U.S. Application Data
(60) Provisional application No. 62/580,663, filed on Nov. 2, 2017.

(51) Int. Cl. H04L 9/08; H04L 1/16; H04L 9/06

(52) U.S. Cl. CPC H04L 9/0869; H04L 9/0833; H04L 9/0662; H04L 1/1621; H04L 9/0631; H04L 9/0822

(57) ABSTRACT

Certain aspects relate to an apparatus includes an interface configured to obtain a first frame including a first information element (IE) indicating a list of encoding algorithms and a processing system configured to generate a second frame including a second IE indicating at least one of an encoding algorithm from the list or the list. The interface is further configured to output the second frame for transmission to a device and obtain a first random number from the device and the processing system is further configured to generate a code based on the first random number, a second random number and a master key and generate a third frame comprising the second IE, the second random number and an integrity protected IE generated based on the second IE and the code. Furthermore, the interface is configured to output the third frame for transmission to the device.

### BACKGROUND

### Claim of Priority under 35 U.S.C. § 119

The present Application for Patent claims priority to Provisional Application No. 62/580,663 entitled “AUTHENTICATION PROTECTION MECHANISM” filed Nov. 2, 2017, and assigned to the assignee hereof and hereby expressly incorporated by reference herein.

### FIELD

The present disclosure relates generally to communications networks, and more particularly, to methods and apparatuses for protecting authentication between devices against potential attacks that would compromise data being exchanged during authentication.

### BACKGROUND

Various wireless technologies are being deployed for wireless communications. One of such wireless technologies is Wi-Fi, which is based on the IEEE 802.11 series of standards for specifying how a wireless client such as a user terminal can connect to the Internet via an access point. Before the user terminal can connect to the Internet, authentication is needed. To do so, the access point and user terminal exchange messages to independently prove to each other that they know the pre-shared key or pairwise master key, without disclosing such key. In addition, the access point and the user terminal need to agree which encoding algorithm will be used by both for securely exchanging data between them. Different types of encoding algorithms such as Advanced Encryption Standard (AES), Data Encryption Standard (DES) and Rivest cipher 6 (RC6) can be used. The more secured the encoding algorithm is, the less likely it would be for data being exchanged to be compromised by attacks.

### BRIEF SUMMARY

The systems, methods, and devices or apparatuses of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide an apparatus for wireless communications. The apparatus generally includes an interface that is configured to obtain a first frame including a first information element (IE) indicating a list of encoding algorithms and a processing system that is configured to generate a second frame including a second IE indicating at least one of an encoding algorithm from the list or the list. In addition, the interface is further configured to output the second frame for transmission to a second apparatus, and thereafter, obtain a first random number from the second apparatus and the processing system is further configured to generate a code based on the first random number, a second random number and a master key and generate a third frame including the second IE, the second random number and an integrity protected IE, said integrity protected IE being generated based on the second IE and the code. Furthermore, the interface is further configured to output the third frame for transmission to the second apparatus.

Certain aspects provide an apparatus for wireless communications. The apparatus generally includes a processing system that is configured to generate a first frame including a first IE indicating a list of encoding algorithms and an interface configured to output the first frame for broadcast to a plurality of wireless nodes, and thereafter, obtain a second frame from one of the plurality of wireless nodes, said second frame including a second IE indicating at least one of an encoding algorithm or a second list of encoding algorithms including the indicated encoding algorithm. In addition, the processing system is further configured to generate a first random number and the interface is further configured to output the first random number for transmission to the one wireless node after obtaining the second frame, and thereafter, obtain a third frame including a third IE, a second random number and an integrity protected IE. Furthermore, the processing system is further configured to obtain a code based on the first and second random numbers and a master key, process the integrity protected IE by using the code to obtain an unprotected IE, compare the unprotected IE with the third IE and take one or more actions based on the comparison.

Aspects generally include methods, apparatuses, computer readable medium, wireless node, access point and access terminal, as substantially described herein with reference to and as illustrated by the accompanying drawings. Numerous other aspects are provided.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example stations, in accordance with certain aspects of the present disclosure.

FIG. 3 illustrates an example wireless device, in accordance with certain aspects of the present disclosure.

FIG. 4 illustrates typical messages being exchanged between an access point and a client during authentication.

FIG. 5 illustrates data being exchanged between an access point and a client in according with inventive aspects being described herein.

FIG. 6 is a flow diagram of example operations for wireless communications, in accordance with certain aspects of the present disclosure.

FIG. 6A illustrates example components capable of performing the operations shown in FIG. 6, in accordance with certain aspects of the present disclosure.

FIG. 7 is a flow diagram of example operations for wireless communications, in accordance with certain aspects of the present disclosure.

FIG. 7A illustrates example components capable of performing the operations shown in FIG. 7, in accordance with certain aspects of the present disclosure.

To facilitate understanding, identical reference numerals have been used, where possible, to designate identical elements that are common to the figures. It is contemplated that elements disclosed in one aspect may be beneficially used on other aspects without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

The word “communicate” is used herein to mean “transmit”, “receive” or “transmit and receive”. The word “communication” or “communications” is used herein to mean “transmission”, “reception” or “transmission and reception”.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Example of Wireless Communications Network

The following description is directed to certain implementations for the purposes of describing the innovative aspects of this disclosure. However, a person having ordinary skill in the art will readily recognize that the teachings herein can be applied in different ways and may be incorporated into various types of communication networks or network components. In some aspects, the teachings herein may be employed in a multiple-access network capable of supporting communication with multiple users by sharing the available network resources (e.g., by specifying one or more of bandwidth, transmit power, coding, interleaving, and so on). For example, the teachings herein may be applied to any one or combinations of the following technologies or standards: Code Division Multiple Access (CDMA), Multiple-Carrier CDMA (MCCDMA), Wideband CDMA (W-CDMA), Time Division Multiple Access (TDMA), Frequency Division Multiple Access (FDMA), Single-Carrier FDMA (SC-FDMA), Orthogonal Frequency Division Multiple Access (OFDMA), IS-95, cdma2000, IS-856, W-CDMA, TDSCDMA, 802.11 (Wi-Fi), 802.16, Global System for Mobile Communication (GSM), Evolved UTRA (E-UTRA), IEEE 802.20, Flash-OFDM®, Long Term Evolution (LTE), Ultra-Mobile Broadband (UMB), Ultra-Wide Band (UWB), Bluetooth®, GSM/General Packet Radio Service (GPRS), Enhanced Data GSM Environment (EDGE), Terrestrial Trunked Radio (TETRA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), AMPS, or other technology of 3G, 4G, or 5G.

The teachings herein may be incorporated into (e.g., implemented within or performed by) a variety of wired or wireless apparatuses (e.g., nodes). In some aspects, a wireless node implemented in accordance with the teachings herein may include an access point or an access terminal.

An access point (“AP”) may include, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may include, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may include a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

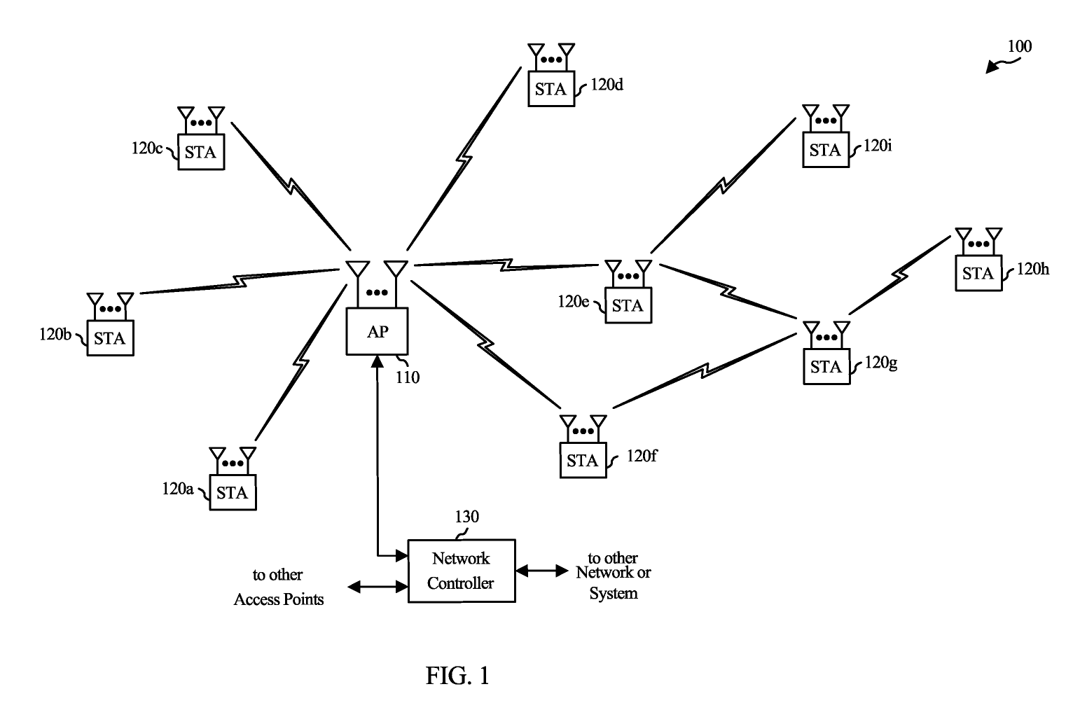

FIG. 1 illustrates a multiple-access network 100 with access points and user terminals. For simplicity, only one access point 110 is shown in FIG. 1. An access point (AP) is generally a fixed station that communicates with the user terminals and also may be referred to as a base station or some other terminology. A user terminal may be fixed or mobile and also may be referred to as a mobile station, an access terminal, a station (STA), a client, a cellular phone, a personal digital assistant (PDA), a handheld device, a wireless modem, a laptop computer, a personal computer, or some other terminology.

The access point 110 may communicate with one or more user terminals or stations 120 at any given moment on the downlink and uplink. The downlink (i.e., forward link) is the communications link from the access point to the user terminals, and the uplink (i.e., reverse link) is the communications link from the user terminals to the access point. A user terminal also may communicate peer-to-peer with another user terminal. A network controller 130 couples to and provides coordination and control for the access points.

The network 100 can be a Multiple Input Multiple Output (MIMO) network by employing multiple transmit and multiple receive antennas for communications on the downlink and uplink. If so, the access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. In some implementations, it may be desirable to have Nₐₚ≥Nᵤ≥1 if the data symbol streams for the Nᵤ user terminals are not multiplexed in code, frequency or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and receives user-specific data from the access point. In general, each selected user terminal may be equipped with one or multiple antennas (i.e., Nᵤₜ≥1). The Nᵤ selected user terminals can have the same or different number of antennas.

The network or system 100 may be a time division duplex (TDD) network or a frequency division duplex (FDD) network. For a TDD network, the downlink and uplink share the same frequency band. For an FDD network, the downlink and uplink use different frequency bands. The network 100 also may utilize a single carrier or multiple carriers for transmission. Each user terminal may be equipped with a single antenna so as to keep costs down or multiple antennas if additional cost can be afforded. The network 100 may represent a high speed Wireless Local Area Network (WLAN) operating in a 60 GHz band.

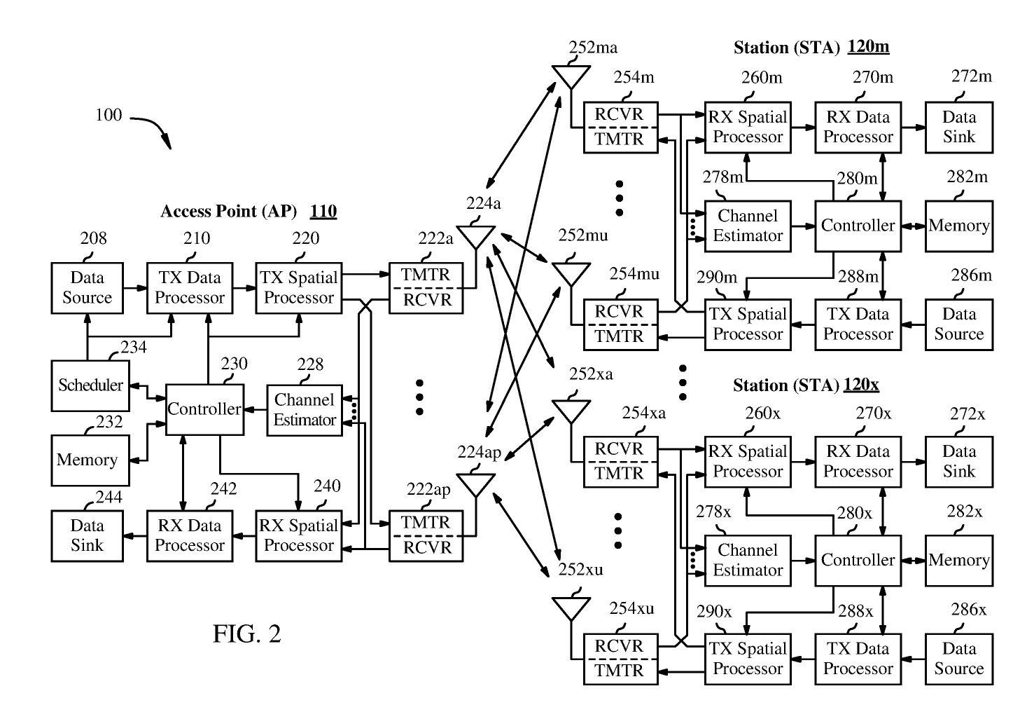

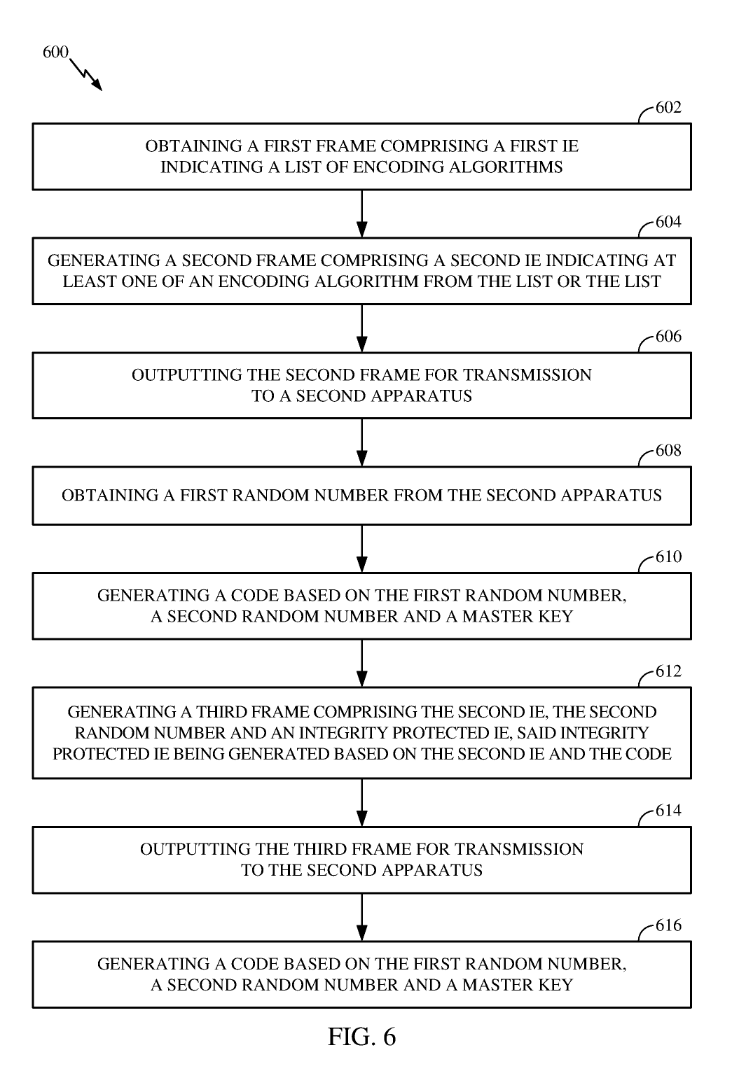

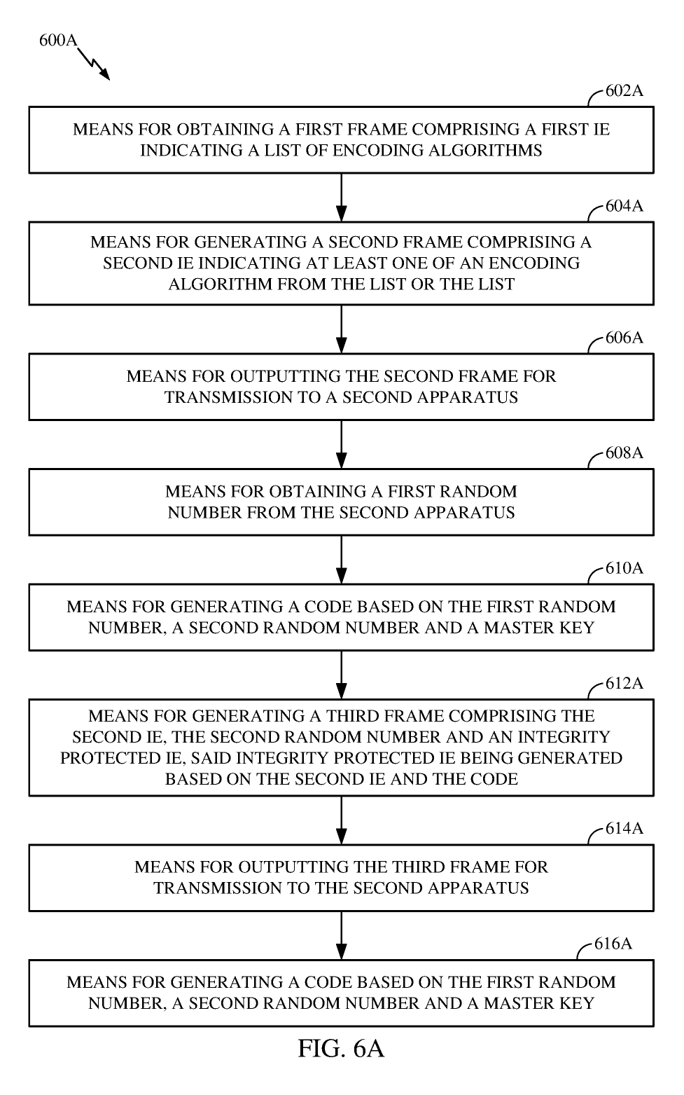

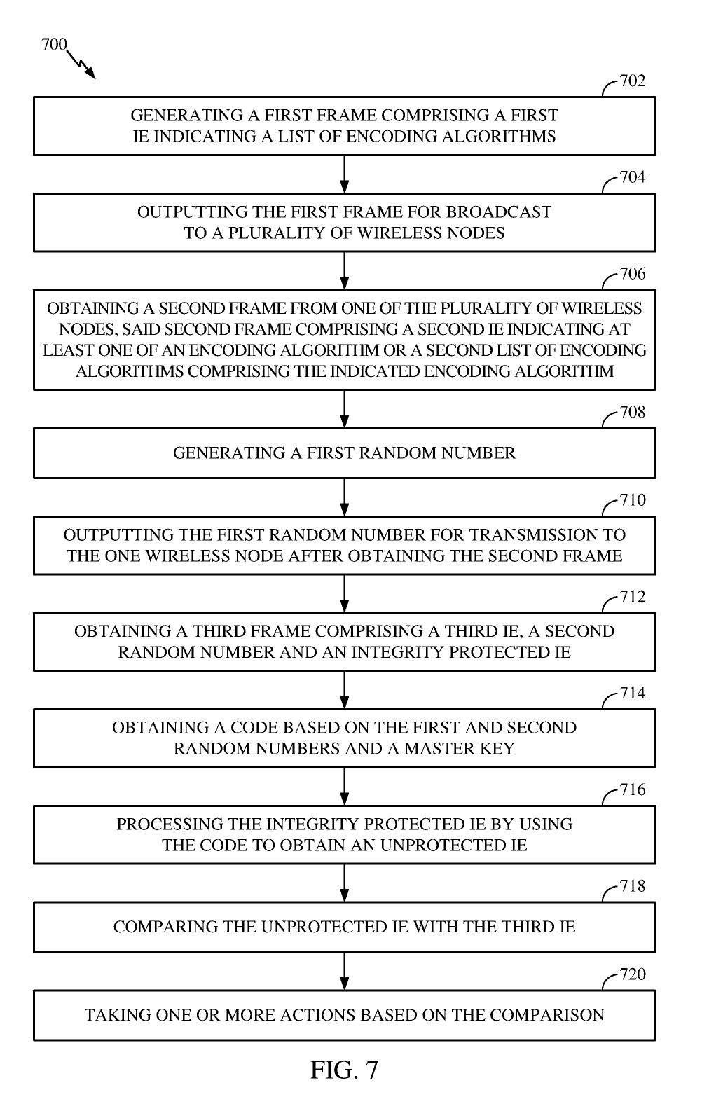

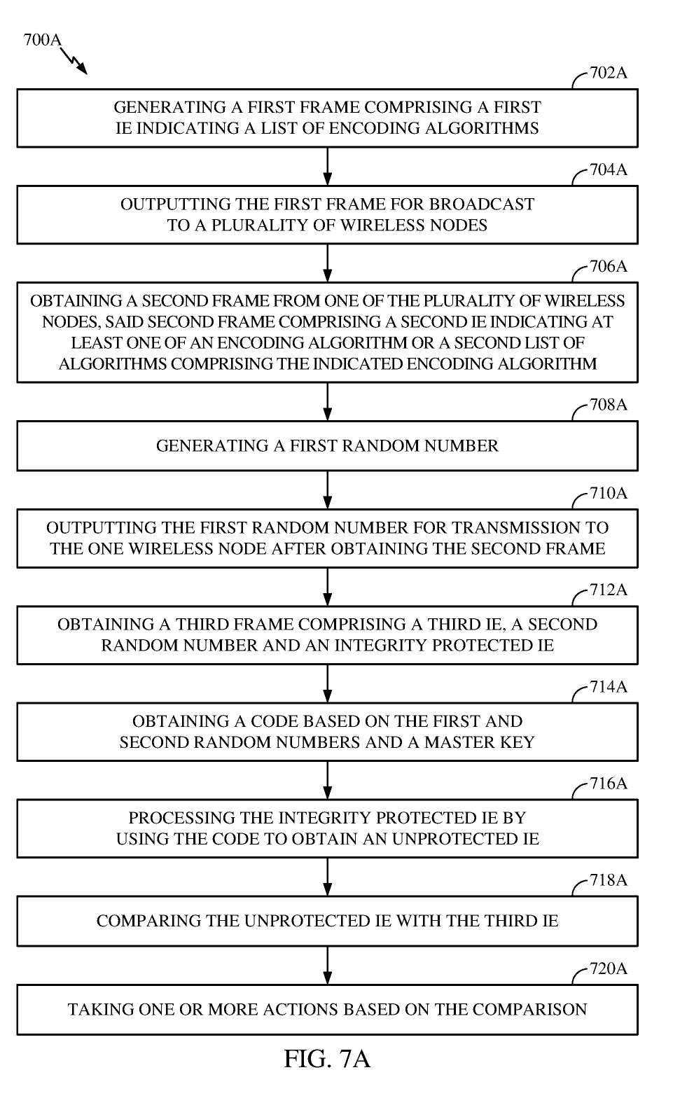

FIG. 2 illustrates example components of the access point 110 and user terminal or station 120 illustrated in FIG. 1, which may be used to implement aspects of the present disclosure. One or more components of the access point 110 and station 120 may be used to practice aspects of the present disclosure. For example, antenna 224, transmitter/receiver unit 222, processors 210, 220, 240, 242, and/or controller 230 or antenna 252, transmitter/receiver 254, processors 260, 270, 288, and 290, and/or controller 280 may be used to perform the operations described herein and illustrated with reference to FIGS. 6, 6A, 7 and 7A.

FIG. 2 shows a block diagram of the access point/base station 110 and two user terminals/user equipment 120m and 120x in a network 100. The access point 110 is equipped with Nₐₚ antennas 224a through 224ap. The user terminal 120m is equipped with N_{ut,m} antennas 252ma through 252mu, and the user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, and N_{dn} user terminals are selected for simultaneous transmission on the downlink. Moreover, Nᵤₚ may or may not be equal to N_{dn}, and Nᵤₚ, and N_{dn} may include static values or can change for each scheduling interval. Beamforming (such as beam-steering) or some other spatial processing techniques may be used at the access point and user terminal.

On the uplink, at each user terminal 120 selected for uplink transmission, a TX data processor 288 receive traffic data from a data source 286 and control data from a controller 280. The controller 280 may be coupled with a memory 282. The TX data processor 288 processes (such as encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m} transmit symbol streams for the N_{ut,m} antennas. Each transmitter unit (TMTR) 254 receives and processes (such as converts to analog, amplifies, filters, and frequency upconverts) a respective transmit symbol stream to generate an uplink signal. The N_{ut,m} transmitter units 254 provide N_{ut,m} uplink signals for transmission from the N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At the access point 110, the Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by the transmitter unit 254 and provides a received symbol stream. An RX spatial processor 240 performs receiver spatial processing on the Nₐₚ received symbol streams from the Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal. An RX data processor 242 processes (such as demodulates, de-interleaves, and decodes) each recovered uplink data symbol stream {s_{up,m}} in accordance with the rate used for that stream to obtain decoded data. The decoded data for each user terminal may be provided to a data sink 244 for storage and a controller 230 for further processing.

On the downlink, at the access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. The TX data processor 210 processes (such as encodes, interleaves, and modulates) the traffic data for each user terminal based on the rate selected for that user terminal. The TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. The Nₐₚ transmitter units 222 provide Nₐₚ downlink signals for transmission from the Nₐₚ antennas 224 to the user terminals. The decoded data for each STA may be provided to a data sink 272 for storage and/or a controller 280 for further processing.

At each user terminal 120, the N_{ut,m} antennas 252 receive the Nₐₚ downlink signals from the access point 110. Each receiver unit (RCVR) 254 processes a received signal from an associated antenna 252 and provides a received symbol stream. An RX spatial processor 260 performs receiver spatial processing on N_{ut,m} received symbol streams from the N_{ut,m} receiver units 254 and provides a recovered downlink data symbol stream {s_{dn,m}} for the user terminal. The receiver spatial processing can be performed in accordance with the CCMI, MMSE, or other known techniques. An RX data processor 270 processes (such as demodulates, de-interleaves, and decodes) the recovered downlink data symbol stream to obtain decoded data for the user terminal.

At each user terminal 120, the N_{ut,m} antennas 252 receive the Nₐₚ downlink signals from the access point 110. Each receiver unit (RCVR) 254 processes a received signal from an associated antenna 252 and provides a received symbol stream. An RX spatial processor 260 performs receiver spatial processing on N_{ut,m} received symbol streams from the N_{ut,m} receiver units 254 and provides a recovered downlink data symbol stream {s_{dn,m}} for the user terminal. The receiver spatial processing is performed in accordance with the CCMI, MMSE, or some other technique. An RX data processor 270 processes (such as demodulates, de-interleaves, and decodes) the recovered downlink data symbol stream to obtain decoded data for the user terminal.

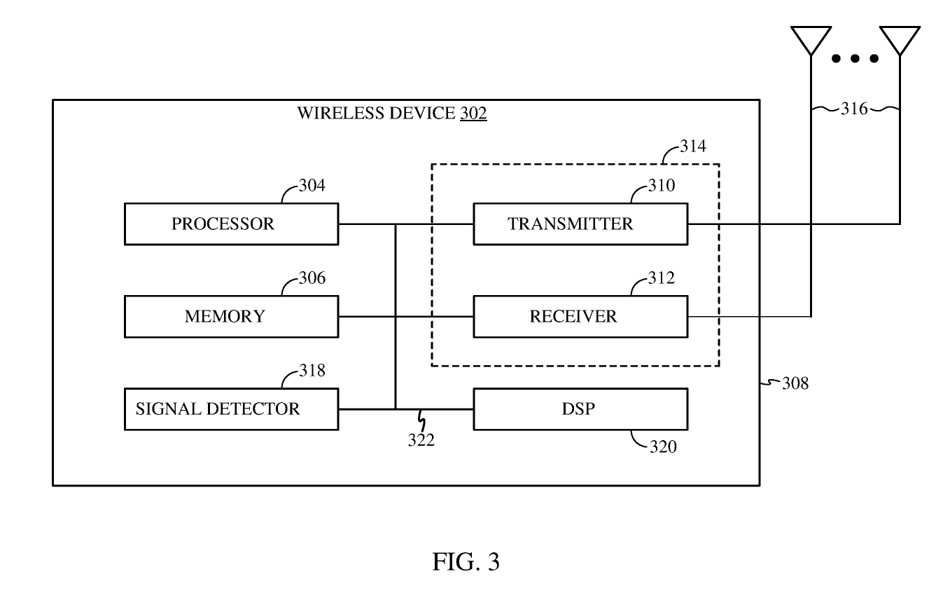

FIG. 3 illustrates various components that may be utilized in a wireless device 302 that may be employed within the network 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 also may be referred to as a central processing unit (CPU). Memory 306, which may include both read-only memory (ROM) and random access memory (RAM), provides instructions and data to the processor 304. A portion of the memory 306 also may include non-volatile random access memory (NVRAM). The processor 304 typically performs logical and arithmetic operations based on program instructions stored within the memory 306. The instructions in the memory 306 may be executable to implement the methods described herein.

The wireless device 302 also may include a housing 308 that may include a transmitter 310 and a receiver 312 to allow transmission and reception of data between the wireless device 302 and a remote location. The transmitter 310 and the receiver 312 may be combined into a transceiver 314. A plurality of transmit antennas 316 may be attached to the housing 308 and electrically coupled to the transceiver 314. The wireless device 302 also may include (not shown) multiple transmitters, multiple receivers, and multiple transceivers.

The wireless device 302 also may include a signal detector 318 that may be used in an effort to detect and quantify the level of signals received by the transceiver 314. The signal detector 318 may detect such signals as total energy, energy per subcarrier per symbol, power spectral density and other signals. The wireless device 302 also may include a digital signal processor (DSP) 320 for use in processing signals.

The various components of the wireless device 302 may be coupled together by a bus system 322, which may include a power bus, a control signal bus, and a status signal bus in addition to a data bus.

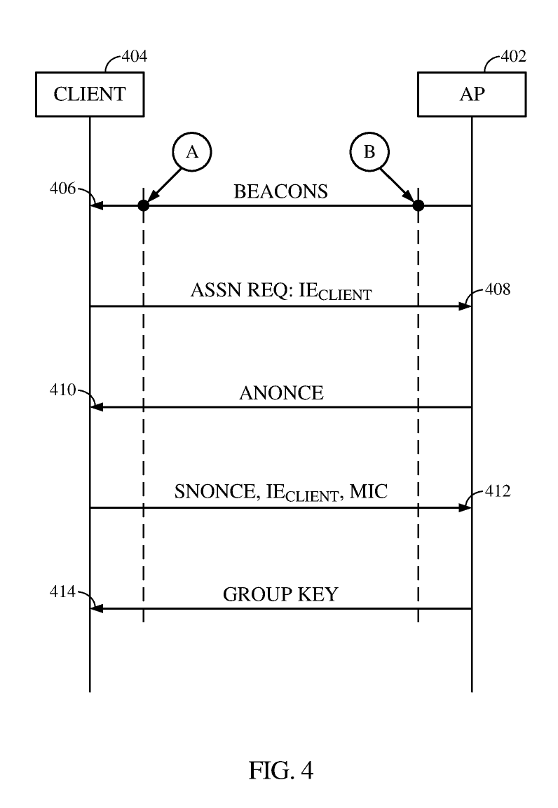

FIG. 4 illustrates typical messages being exchanged between an access point (AP) 402 and a client 404 such as a user terminal during authentication. The AP 402 advertises a list of encoding algorithms or ciphers (list_{AP}) supported by such AP to be used for encoding data after authentication is completed. Some examples of encoding algorithms include DES, Triple DES (3DES), which extends the key size of DES by applying the algorithm three times in succession with three different keys, RC6, Blowfish and AES. The AP 402 can advertise such list by transmitting a frame such a beacon frame 406 or broadcasting the frame having the list therein. More specifically, the frame includes a field or an Information Element (IE) that in turn includes an indication of the list. When the client 404 receives the list, it chooses one of the encoding algorithms from the list. Typically, the client 404 will choose the most secured encoding algorithm from the list that is also being supported by client. That way, the exchange of data after authentication will be more secure.

After choosing the encoding algorithm, the client 404 sends an association request (Assn Req) 408 with an indication of the chosen encoding algorithm therein. The association request can have a field or an IE having the indication of the chosen encoding algorithm therein. When the AP 402 receives association request with the IE_{client} therein, the AP 402 generates and transmits a first message 410 including a random number such as an ANonce to the client 404. After receiving the ANonce, the client generates a second message 412 including a random number such as a SNonce, the IE_{client} and a Message Integrity Code (MIC). The MIC is generated based on the received ANonce, SNonce and a master key being known to both client 404 and AP 402 but not being known to the attacker. Thereafter, the client 404 transmits the second message 412 to the AP 402.

After receiving the second message 412, the AP generates its own MIC by using the received SNonce, ANonce and the master key and then compare its generated MIC with the received MIC and if they match, the AP 402 will encode a group key (GK) by using the encoding algorithm indicated in the IE_{client} and transmits a third message 414 having such encoded group key therein to the client 404 so that the client 404 can securely receive multicast or broadcast messages from the AP 402. The group key is a shared key that is known to all clients being connected to the AP 402.

The exchange of data as described above is vulnerable to attacks and thus data being exchanged during and after authentication would be compromised. For example, an attacker will try to downgrade or lower the level of security associated with communications between the AP 402 and the client 404. Less secured communications mean it will easier for the attacker to decode the encoded data of such communications.

To downgrade the security level of communications between the AP 402 and the client 404, the attacker can be located at point A, spoof the MAC address of the client 404 and intercept data being exchanged between the AP 402 and client 404. More specifically, the attacker can intercept the second message 412 being sent from the client 404 to the AP 402 and then only replace the IE_{client} with IE_{attack} having an indication of an encoding algorithm that is less secured than the encoding algorithm indicated in the IE_{client}. For example, if the IE_{client} indicates AES, the IE_{attack} would indicate RC6, which is easier to decode than AES. When the AP 402 receives the attacker's message, the MIC in the attacker's message still matches with the MIC generated at the AP 402 since the SNonce has not changed and thus the AP 402 proceeds to use the encoding algorithm indicated by IE_{attack}, which is RC6 in this example, to encode the group key and thereafter transmit such encoded group key to the client 404 without knowing that the attacker's preference for RC6 being used. As a result, it will be easier for the attacker to decode or decipher the encoded group key since computation power needed to decode RC6 data is less than computation power needed to decode AES data. Accordingly, the attacker knows the group key and thus the attacker can, for example, inject any traffic into the network and, also, decode traffic transmitted over the network.

Instead of replacing IE_{client} with IE_{attack}, the attacker can also be located at point B, spoof the MAC address of the AP 402, intercept the list of encoding algorithms indicated in the beacon frame 406 and replaced such list with attacker's list of encoding algorithms that are capable of being decoded by the attacker. When the client 404 receives the attacker's list, the client basically is choosing one of the attacker's preferred encoding algorithms and accordingly, data will be compromised.

The following examples of apparatuses, methods, computer readable mediums, access terminal and access point effectively detect potential attacks during authentication and abort the authentication process.

### Example of Authentication Protection Mechanism

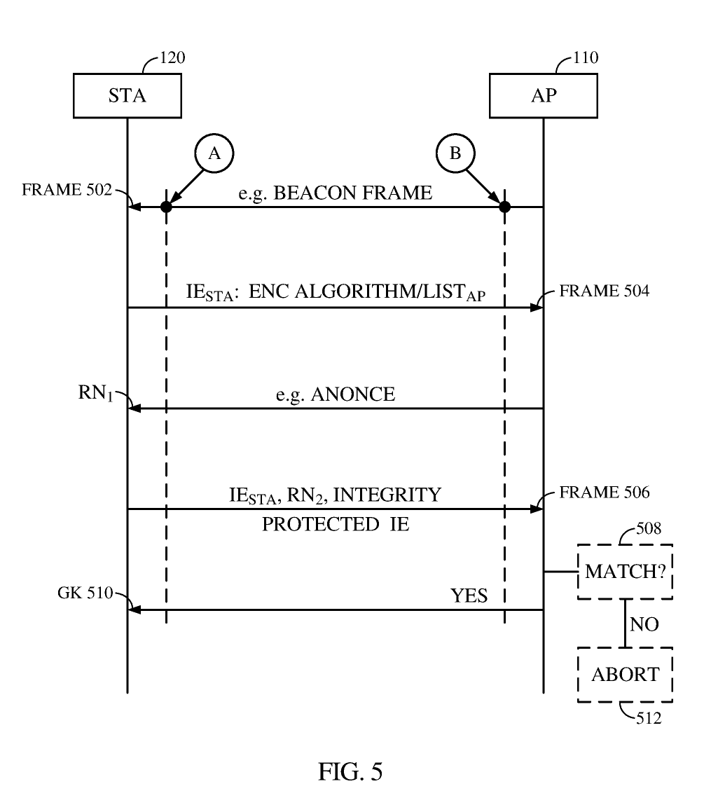

FIG. 5 illustrates data being exchanged between an access point and a client in according with inventive aspects being described herein with respect to FIG. 6, FIG. 6A, FIG. 7 and FIG. 7A. The access point is the AP 110 of FIG. 1 or FIG. 2 and the client is one of the stations of FIG. 1 or STA 120m of FIG. 2.

FIG. 6 is a flow diagram of example operations 600 for wireless communications, in accordance with certain aspects of the present disclosure. The operations 600 may be performed by an apparatus or a wireless device 302 of FIG. 3. In certain aspects, the wireless device 302 is the STA 120m.

At block 602, the STA 120m obtains a first frame 502 including a first IE indicating a list of encoding algorithms (list_{AP}). The first frame 502 includes a beacon frame or a broadcast frame generated by the AP 110.

At block 604, the STA 120m generates a second frame 504, which includes a second IE (IE_{STA}) indicating at least one of an encoding algorithm from the list_{AP}. More specifically, the STA 120m chooses one of the encoding algorithm from the list and the second IE indicates the chosen encoding algorithm. After generating the second frame 504, the STA 120m then outputs the second frame 504 for transmission to the AP 110 at block 606.

In certain aspects, the IE_{STA} of the second frame indicates both the chosen encoding algorithm and the list_{AP} so that when the AP 110 receives the second frame, it can verify whether the received list is the same as the list_{AP} since the IE_{STA} could be replaced with IE_{attack} as discussed above. If the received list does not match with the list_{AP}, the AP 110 can immediately stop communicating with the STA 120m, i.e., abort all further operation associated with the STA 120m.

After the transmission of the second frame, the STA obtains a first random number (RN₁) from the AP 110 at block 608. The fist random number includes an ANonce generated by the AP 110.

At block 610, the STA generates a code_{STA} based on the first random number, a second random number (RN₂) and a master key. In one aspect, code_{STA} is a Message Integrity Code (MIC). The second random number includes an SNonce and is generated by the STA. Regarding the master key, such master key is known a priori by the STA 120m and the AP 110 and include a pairwise master key (PMK).

At block 612, the STA 120m generates a third frame 506, which includes (i) the IE_{STA}, which indicates the chosen encoding algorithm, the list_{AP} or both as discussed above, (ii) the second random number and (iii) an integrity protected IE. More specifically, the STA 120m generates the integrity protected IE by using the IE_{STA} and the code. That is, the integrity protected IE is an encoded IE. Effectively, the third frame 506 includes an unprotected IE_{STA} and a “protected” IE_{STA}. In certain aspects, the third frame 506 can also include the code that was generated by the STA 120m and used by STA to generate the integrity protected IE.

Thereafter, the STA 120m outputs the third frame for transmission to the AP 110 at block 614. In certain aspects, the third frame 506 is output for unicast transmission to the AP 110.

An attacker located at point A can certainly intercept the third frame 506 and transmits attacker's version of the third frame in which IE_{STA} is replaced with IE_{attack} but the integrity protected IE and second random number are still present. After receiving the attacker's version of the third frame, the AP 110 uses the received second random number, first random number and the master key to generate a code_{AP}, which is the same as the code_{STA}, uses code_{STA} to decode the integrity protected IE to obtain the IE_{STA} and then compare the obtained IE_{STA} to the IE_{attack} per block 508 of FIG. 5. This comparison obviously indicates no match and thus the AP 110 can immediately stop communicating with the STA 120m, abort any further operation associated with STA 120m per block 510 of FIG. 5 or both. Accordingly, by providing both unprotected IE_{STA} and “protected” IE_{STA} in the same frame, the STA 120m effectively enables the AP 110 to detect any attack and if so, abort the authentication process.

Furthermore, an attacker located at point B can intercept the first frame 502 and replace the list_{AP} with attacker's list_{attack} of encoding algorithms that the attacker is capable of decoding if used to encode. Accordingly, in certain aspects, the IE_{STA} can also include an indication of the list of encoding algorithms from which the STA 120m had chosen the encoding algorithm to be used by both STA 120m and AP 110. Since IE_{STA} of the second frame 504 indicating both the chosen encoding algorithm and the list, the AP 110 can verify whether the received list matches the APₗᵢₛₜ. If so, the AP 110 would continue with the authentication process and if not, the AP 110 would abort the authentication process.

In addition to replacing list_{AP} with list_{attack} in frame 502, the attacker can also intercept the second frame 504 and replace the list_{attack} back with list_{AP} so that the AP 110 does not know that the STA 120m had chosen from list_{attack}. Furthermore, the attacker can intercept the third frame 506 and replace the list_{attack} with list_{AP} in the unprotected IE_{STA} so that the AP 110 would think the STA 120m had received list_{AP}. Since the third frame 506 includes both unprotected IE and “protected” IE, any tampering of the unprotected IE will be detected because the tampered IE with list_{AP} won't match the IE obtained from decoding the “protected” IE because the IE obtained from such decoding will indicate list_{attack}, which was received and used by the STA 120m.

FIG. 7 is a flow diagram of example operations 700 for wireless communication, such as authentication, in accordance with certain aspects of the present disclosure. The operations 700 may be performed by an apparatus that can be configured as a wireless device 302 being illustrated in FIG. 3. In certain aspects, such wireless device 302 is the AP 110 communicating with a plurality of wireless nodes such as stations as illustrated in FIG. 1.

At block 702, the AP 110 generates a first frame such as frame 502 having a first IE indicating a list (list_{AP}) of encoding algorithms and then, at block 704, outputs the first frame 502 for broadcast to a plurality of the stations. Since the stations can support different encoding algorithms, the list will enable each station to choose the one it would like to use to communicate with the AP 110. In certain aspects, the first frame includes a beacon frame.

At block 706, the AP 110 obtains a second frame such as frame 504 from one of the plurality of stations such as STA 120m. The second frame includes a second IE indicating an encoding algorithm or a second list of encoding algorithms including the indicated encoding algorithm. In certain aspects, the second list is the same as the list_{AP}. In other aspects, the second list is not the same as list_{AP} because an attacker located at point B could have intercepted the first frame 502 and replaced list_{AP} with list_{attack} having encoding algorithms that are less secured than the encoding algorithms of list_{Ap} and thus, at this time, the STA 120m is only aware of list_{attack}. Accordingly, the second list indicated by the second IE would be list_{attack}, not list_{AP}.

After obtaining the second frame 504 from the STA 120m, at block 708, the AP 110 generates a first random number such as an ANonce. In certain aspects, the AP 110 only generates the first random number if the obtained second list indicated by the second IE is the same as the list_{AP}, which was broadcasted by the AP 110. If the obtained second list is different from the list_{AP}, the AP 110 can immediately stop communicating with the STA 120m since the list_{AP} broadcasted by the AP 110 either was tampered with or was not received by the STA 120m.

After the first random number is generated, it gets outputted for transmission to the STA 120m at block 710. The first random number will enable the STA 120m to continue with the authentication process.

At block 712, the AP 110 obtains a third frame including a third IE, a second random number such as SNonce and an integrity protected IE. In certain aspects, the obtained third IE is the same as the obtained second IE per block 706 if the third frame was truly transmitted by the STA 120. In other aspects, the third IE is not the same as the second IE because an attacker located at point B had intercepted a frame such as frame 506 transmitted by the STA 120m and replaced the IE in the frame 506 with IE_{attack} indicating an encoding algorithm that is less secured than the one indicated in the third IE transmitted by the STA 120m.

At block 714, the AP 110 obtains a code based on the received second random number, the first random number and a master key known a priori to both the STA 120m and AP 110. At block 716, the AP 110 processes the integrity protected IE by using the code to obtain an unprotected IE since the integrity protected IE was generated based on another code that was also obtained based on the same first and second random numbers and the same master key.

At block 718, the AP 110 compares the unprotected IE with the third IE and, at block 720, the AP 110 takes one or more actions based on the comparison.

In certain aspects, if the comparison indicates that unprotected IE and the third IE are the same, which means the third IE was truly transmitted by the STA 120m, the one or more actions include encoding a group key by using the encoding algorithm indicated in the third IE.

In certain aspects, the third IE indicates an encoding algorithm and a list of encoding algorithms including the indicated encoding algorithm. In these aspects, even if the comparison indicates that unprotected IE and the third IE are the same, the AP 110 can also determine whether the list is the same as list_{AP}. If lists are the same, AP encodes a group key by using the encoding algorithm indicated in the third IE and then outputs the encoded group key 510 for transmission to the STA 120m. If the lists are not the same, the AP immediately stops communicating with or aborts any further operation associated with the STA 120m since the STA 120m was not using the list_{AP} to choose its encoding algorithm.

In certain aspects, the obtained third frame also can include a code. If the code was truly transmitted by the STA 120m, such code is the code that was used to generate the integrity protected IE included in the third frame. The AP 110 can determine whether the code obtained per block 714 matches the code in the third frame. If the lists are the same, AP encodes a group key by using the encoding algorithm indicated in the third IE and then transmits the encoded group key 510 to the STA 120m. If the lists are not the same, the AP immediately stops communicating with or aborts any further operation associated with the STA 120m since the STA 120m was not using the list_{AP} to choose its encoding algorithm.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” For example, the articles “a” and “an” as used in this application and the appended claims should generally be construed to mean “one or more” unless specified otherwise or clear from the context to be directed to a singular form. Unless specifically stated otherwise, the term “some” refers to one or more. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. More specifically, operations 600 illustrated in FIG. 6 correspond to means 600A illustrated in FIG. 6A and operations 700 illustrated in FIG. 7 correspond to means 700A illustrated in FIG. 7A.

For example, means for transmitting (or means for outputting for transmission) may include a transmitter (e.g., the transmitter unit 222) and/or an antenna(s) 224 of the access point 110 or the transmitter unit 254 and/or antenna(s) 252 of the station 120 illustrated in FIG. 2 or a bus and/or bus interface or any combination thereof. Means for receiving (or means for obtaining) may include a receiver (e.g., the receiver unit 222) and/or an antenna(s) 224 of the access point 110 or the receiver unit 254 and/or antenna(s) 252 of the station 120 illustrated in FIG. 2 or a bus and/or bus interface or any combination thereof. Means for processing, means for determining, means for obtaining, means for generating, means for decoding, means for comparing, means for taking one or more actions, or means for aborting may include a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the station 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may include a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communications media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, phase change memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may include a single instruction, or many instructions, and may be distributed over several different code segments, among different programs, and across multiple storage media. The computer-readable media may include a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may include non-transitory computer-readable media (e.g., tangible media). In addition, for other aspects computer-readable media may include transitory computer-readable media (e.g., a signal). Combinations of the above should also be included within the scope of computer-readable media.

Thus, certain aspects may include a computer program product for performing the operations presented herein. For example, such a computer program product may include a computer-readable medium having instructions stored (and/or encoded) thereon, the instructions being executable by one or more processors to perform the operations described herein. For example, instructions for performing the operations described herein and illustrated in the appended figures.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications comprising:
an interface configured to obtain a first frame comprising a first information element (IE) indicating a list of encoding algorithms; and
a processing system configured to generate a second frame comprising a second IE indicating at least one of an encoding algorithm from the list or the list, wherein:
the interface is further configured to output the second frame for transmission to a second apparatus, and thereafter, obtain a first random number from the second apparatus;
the processing system is further configured to:
generate a code based on the first random number, a second random number and a master key; and
generate a third frame comprising the second IE, the second random number and an integrity protected IE, said integrity protected IE being generated based on the second IE and the code; and
the interface is further configured to output the third frame for transmission to the second apparatus.

2. The apparatus of claim 1, wherein:
the interface is further configured to obtain, after outputting the third frame, an encoded group key from the second apparatus; and
the processing system is further configured to decode the encoded group key by using the encoding algorithm indicated by the second IE to obtain the group key.

3. The apparatus of claim 1, wherein:
the processing system further configured to generate an acknowledgment in response to obtaining the group key; and
the interface is further configured to output the acknowledgment for transmission to the second apparatus.

4. The apparatus of claim 1, wherein first frame comprises a broadcast frame or a beacon frame.

5. The apparatus of claim 1, wherein the encoding algorithms comprise AES, 3DES, DES, Blowfish, RC2, RC5, and RC6.

6. The apparatus of claim 1, wherein the processing system is further configured to generate the second random number.

7. The apparatus of claim 1, wherein the master key is known by both the apparatus and the second apparatus.

8. The apparatus of claim 1, wherein the third frame further comprises the code.

9. The apparatus of claim 1, wherein the third frame is output for unicast transmission to the second apparatus.

10-28. (canceled)

29. An access terminal comprising:
a transceiver configured to receive a first frame comprising a first IE indicating a list of encoding algorithms; and
a processing system configured to generate a second frame comprising a second IE indicating at least one of an encoding algorithm from the list or the list, wherein:
the transceiver is further configured to transmit the second frame to a second apparatus, and thereafter, receive a first random number from the second apparatus;
the processing system is further configured to:
generate a code based on the first random number, a second random number and a master key; and
generate a third frame comprising the second IE, the second random number and an integrity protected IE, said integrity protected IE being generated based on the second IE and the code; and
the transceiver is further configured to transmit the third frame to the second apparatus.

30. An apparatus for wireless communications comprising:
a processing system configured to generate a first frame comprising a first IE indicating a list of encoding algorithms; and
an interface configured to output the first frame for broadcast to a plurality of wireless nodes, and thereafter, obtain a second frame from one of the plurality of wireless nodes, said second frame comprising a second IE indicating at least one of an encoding algorithm or a second list of encoding algorithms comprising the indicated encoding algorithm, wherein:
the processing system is further configured to generate a first random number;
the interface is further configured to:
output the first random number for transmission to the one wireless node after obtaining the second frame; and thereafter,
obtain a third frame comprising a third IE, a second random number and an integrity protected IE; and
the processing system is further configured to:
obtain a code based on the first and second random numbers and a master key;
process the integrity protected IE by using the code to obtain an unprotected IE;
compare the unprotected IE with the third IE; and
take one or more actions based on the comparison.

31. The apparatus of claim 30, wherein:
if the comparison indicates that unprotected IE and the third IE are the same, the one or more actions comprise encoding a group key by using the encoding algorithm indicated in the second IE; and
the interface is further configured to output the encoded group key for transmission.

32. The apparatus of claim 30, wherein:
the third IE and the second IE are different;
the third IE is configured to indicate an encoding algorithm and a third list of encoding algorithms; and
if the comparison indicates that unprotected IE and the third IE are the same, the one or more actions further comprise determining whether the third list and the list are the same;
if the determination indicates the third list and the list are the same, the one or more actions further comprise encoding a group key by using the encoding algorithm indicated in the third IE and the interface is further configured to output the encoded group key for transmission; and
if the determination indicates the third list and the list are different, the one or more actions further comprise aborting any further operation associated with the one wireless node.

33. The apparatus of claim 30, wherein:
if the comparison indicates that the unprotected IE and the third IE are different, the one or more actions comprise aborting any further operation associated with the one wireless node.

34. The apparatus of claim 30, wherein the processing system is configured to generate the first random number if the second list and the list are the same.

35. The apparatus of claim 30, wherein:
the third frame further comprises a second code that was used to generate the integrity protected IE; and
the processing of the integrity protected IE comprises:
determining whether the code and the second code are the same;
processing the integrity protected IE by using the code if the code and the second code are the same; and
abort any further operation associated with the one wireless node if the code and the second code are not the same.

36. The apparatus of claim 30, wherein first frame comprises a beacon frame.

37. The apparatus of claim 30, wherein the encoding algorithms comprise AES, 3DES, DES, Blowfish, RC2, RC5, and RC6.

38. The apparatus of claim 30, wherein the master key is known by both the apparatus and the second apparatus.

39-60. (canceled)

61. The apparatus of claim 30 further comprising:
a transceiver configured to transmit the first random number and receive the third frame, wherein the apparatus is configured as an access point.
